(19) United States
(12) Patent Application Publication
(10) Pub. No.: US 2008/0198158 A1
(43) Pub. Date: Aug. 21, 2008

(54) 3D map display system, 3D map display method and display program

(75) Inventors: Kazuaki Iwamura, Nishitokyo (JP); Ryuji Mine, Kokubunji (JP); Yoriko Kazama, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/005,310

(22) Filed: Dec. 27, 2007

(30) Foreign Application Priority Data
Feb. 16, 2007 (JP) 2007-036206

(51) Int. Cl. G06T 15/20

(52) U.S. Cl. 345/419; 345/421

(57) ABSTRACT

A three-dimensional (3D) map display system for outputting display information on a 3D map includes: a processor for performing arithmetic processing; and a memory connected to the processor. The memory stores 3D map vector data for each of partitioned areas determined in advance according to coordinates and a real landscape photograph texture image to be attached to the 3D map vector data. The processor determines whether to display each surface constituting a 3D figure included in the 3D map vector data; stores display object management data which includes a result of the determination as to whether to display the surface, in the memory; and refers to the display object management data stored in the memory to determine that only a surface that faces a view line direction is to be displayed, and that a surface that does not face the view line direction is not to be displayed.

### CLAIM OF PRIORITY

The present application claims priority from Japanese application JP 2007-036206 filed on Feb. 16, 2007, the content of which is hereby incorporated by reference into this application.

### FIELD OF THE INVENTION

The present invention relates to a geographic information system and more particularly to a method of displaying a three-dimensional landscape image at higher speed.

### BACKGROUND OF THE INVENTION

In geographic information systems, three-dimensional (3D) landscape images are displayed with corresponding photographs being attached. However, in order to scroll a 3D map to display a different part thereof, a calculation amount required for the display becomes very large. With a conventional computing ability, the display cannot follow a scrolling action instructed by operating a keyboard or a mouse. For this reason, in some cases, video is displayed during the scrolling action.

Methods of reducing the amount of data required for display by simplifying the display have been proposed. Specifically, JP-A No. 2001-167288 discloses a technique of determining whether to display an object based on the height of the object and the distance to the object. Further, JP-A No. 10 (1998)-332396 discloses a technique in which a structure located near the view point is displayed in detail and an object located far from the view point is displayed with a simplified figure. Furthermore, JP-A No. 11 (1999)-259685 discloses a technique of displaying a realistic image by using video footage in place of 3D computer graphics.

### SUMMARY OF THE INVENTION

In the above-mentioned background art, detailed figures are graphically displayed. When photograph texture images are attached to 3D figures to be displayed, the number of photograph texture images to be attached is limited. In particular, an object having a complicated figure requires several hundreds of photograph texture images. Accordingly, when a scrolling action is performed to move the view point and change a display area, if several hundreds of photograph texture images are all displayed, the display hardly follows the scrolling action.

This is because the amount of data of the photograph texture images is large, a calculation amount required to deform photograph figures by perspective transformation becomes extremely large, and the load for display processing is high. For this reason, there are methods using special hardware for display processing. However, in many cases, their computing abilities are not sufficient when a large amount of 3D figure data is displayed and the 3D figure data is displayed with real landscape texture images being attached, as in the geographic information systems.

Further, in some cases, the amount of data of display object photographs is extremely large, and therefore, the number of photograph images to be displayed is limited by a restricted amount of memory installed in a computer. Accordingly, it is difficult to display all of buildings in an urban area and buildings having complicated figures, with photograph images being attached thereto, and to perform a scrolling action in real time or almost in real time.

Meanwhile, a high-speed display system with computer graphics using a display list has been proposed. However, when buildings to which several hundreds of photographs are attached are displayed, the display cannot follow a scrolling action in some cases.

A representative form of the present invention will be described below. Specifically, a three-dimensional (3D) map display system for outputting display information on a 3D map includes: a processor for performing arithmetic processing; and a memory connected to the processor. The memory stores 3D map vector data managed for each of partitioned areas expressed and determined in advance according to coordinates; and a real landscape photograph texture image to be attached to the 3D map vector data. The processor determines whether to display each display object surface; stores the result of the determination for each display object surface as display object management data in the memory; and refers to the display object management data stored in the memory to determine that only a surface that faces a view line direction is to be displayed, and that a surface that does not face the view line direction is not to be displayed. As a result, the amount of display data is reduced.

According to the present invention, it is possible to display a 3D map including complicated 3D figures and their real landscape photograph texture images at higher speed.

### BRIEF DESCRIPTION OF THE DRAWINGS

FIG. 1 is an explanatory diagram of a three-dimensional (3D) map displayed according to an embodiment of the present invention;

FIG. 2A, FIG. 2B, and FIG. 2C are explanatory diagrams showing changes in display caused by a scrolling action, according to the embodiment of the present invention;

FIG. 3 is a cross-sectional diagram taken along a view line direction in a 3D map displayed according to the embodiment of the present invention;

FIG. 4 is a function block diagram showing the configuration of a 3D map display system according to the embodiment of the present invention;

FIG. 5 is an explanatory diagram showing how to create constituent surfaces using control surfaces and a control point, according to the embodiment of the present invention;

FIG. 6 is an explanatory diagram of display object management data according to the embodiment of the present invention;

FIG. 7 is an explanatory diagram of display surfaces and display object management data according to the embodiment of the present invention;

FIG. 8 is a flowchart of scroll processing according to the embodiment of the present invention;

FIG. 9 is a flowchart of the scroll processing according to the embodiment of the present invention;

FIG. 10 is a flowchart of the scroll processing according to the embodiment of the present invention; and

FIG. 11 is a flowchart of the scroll processing according to the embodiment of the present invention.

### DETAILED DESCRIPTION OF THE PREFERRED EMBODIMENT

First, an outline of an embodiment of the present invention will be described.

In the embodiment of the present invention, a three-dimensional (3D) map is displayed by the following method in which data is simplified and rear surfaces of structures are not displayed, in order to increase a 3D-map display speed. As a result, the amount of display data, calculation resources for display, and the time required for display are reduced.

(1) Surfaces (rear surfaces) that does not face the view line direction are not displayed. Whether a surface is a rear surface is determined through calculation. Therefore, even when the view point is moved by scrolling or rotating the 3D map, it is automatically determined whether to display each surface.

(2) Structures located far from the view point are displayed in a simplified manner. Specifically, the figure of a structure in a far distance area is transformed into a circumscribed rectangle, and a 3D figure created using the circumscribed rectangle is displayed. When the figure of a structure is complicated and has many display surfaces, resources are used for calculation for display and a long time is required for display. However, when the circumscribed rectangle is used, the number of surfaces of the structure can be reduced to five (four wall surfaces and one top surface) at most.

(3) In an area far from the view point, only high structures are displayed in a simplified manner.

(4) Only a ground surface in an area near the view point is displayed with its photograph texture image being attached. Ground surfaces in the other areas are graphically displayed.

(5) Only structures in the area near the view point are displayed with their photograph texture images being attached. Structures in the other areas are graphically displayed.

(6) During a scrolling action, photograph texture image display is not performed but graphic display is performed. Further, during the scrolling action, only high structures are displayed. When the scrolling action is stopped, low structures are also displayed.

In the embodiment of the present invention, display object management data is employed to use the display method, described above. The display object management data includes, for each constituent surface of a detailed 3D figure having texture, the coordinates (two sets of coordinates) of a normal line vector, whether the surface is to be displayed or not, and a display list number.

Note that the present invention can be realized by software. A desktop computer, a notebook computer which can display graphic information, or a mobile compact terminal is used to access 3D map data and retrieve the 3D map data. When a processor therein executes a program according to the present invention, the 3D map data is displayed on the display screen and the displayed 3D map data is scrolled.

The present invention can be applied to routing assistance with mobile terminals (for example, cellular phones), visibility-measurement simulation using a 3D map, and entertainment software such as game programs, allowing a displayed 3D map to be scrolled at higher speed.

In the embodiment of the present invention, means for solving the problem of slow display speed is implemented in a computer, so that it is possible to display and scroll a 3D map including real landscape images at higher speed. In order to perform processing for graphic and the like at higher speed, a transform method for an image registered in a display list is stored in advance in special hardware of a computer. When the method of the present invention is also used at that time, the display speed can be further increased. In particular, since a display parameter is generated in advance in the display list, calculation for display is performed at higher speed. Therefore, the display list number is specified. The display list number is specified in a display command, so that the image data can be displayed according to predetermined processing.

A 3D map is generated and displayed by adding height information to a planar map or by generating figures of wall surfaces of a building or the like with 3D coordinates. Further, when photographs are attached to 3D figures included in the 3D map, 3D real landscape images can be displayed. Attachment of a photograph image of a real landscape is called texture mapping.

However, when the view point or the view line direction is changed while ground surfaces and buildings to which photograph images of real landscapes have been attached are being displayed, a large calculation load to change the display area in the 3D map is imposed on a central processing unit (CPU) of the computer. An increase in the amount of data used to change the display area leads to an increase in the calculation amount and to a reduction in the display speed. In particular, in a case of displaying a 3D map, it is pointed out that attaching real landscape photograph textures reduces the display change speed.

Thus, the following methods are proposed to prevent the display speed from being reduced even when the view point or the view line direction is changed.

(1) Whether to display an object is determined based on the height of the object viewed from the view point and the distance from the view point to the object.

(2) In a near distance area, detailed figures are displayed. In a far distance area, simplified figures are displayed.

However, even with those methods, it takes much time for display when a real landscape (real landscape texture mapping) is involved. In particular, a building having a complicated figure sometimes requires several hundreds of real landscape textures to be attached to its wall surfaces. When each real landscape texture has a large amount of data, it takes much time for display processing, so that after the display processing starts, the operation of the computer seems to be stopped until it ends.

In the present invention, even when real landscape photograph image display is involved, a 3D map is displayed on the display screen of the computer at higher speed. Further, a display method is shown in which, even when a scrolling action for changing the coordinates of the view point or the view line direction is performed through a key operation or a mouse operation, display can smoothly follow the scrolling action.

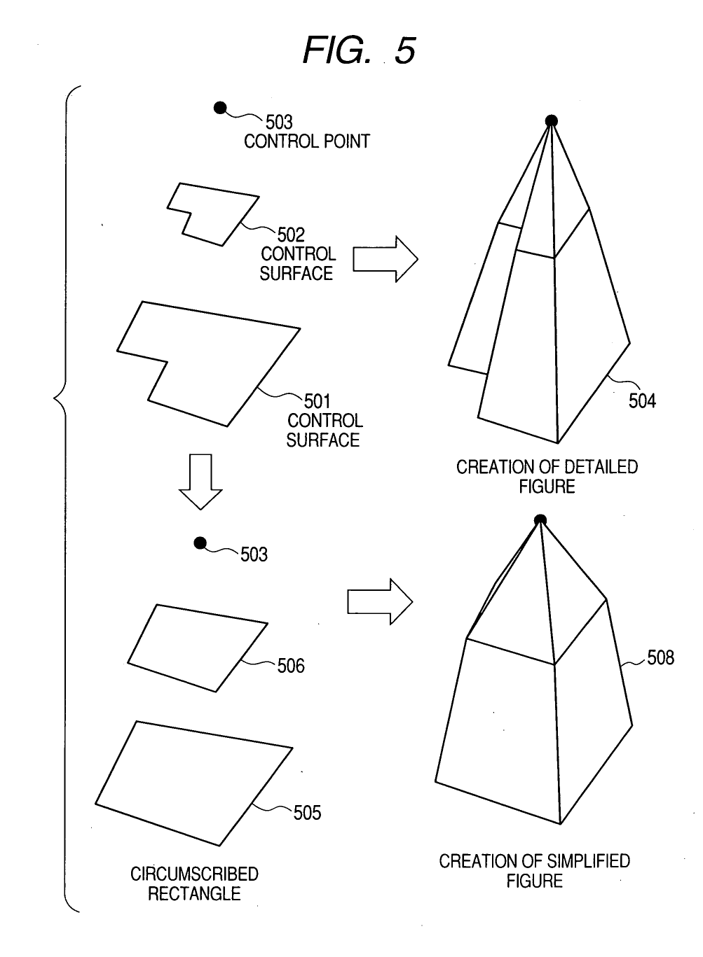

In this embodiment, as shown in FIG. 5, a 3D figure is constituted by control surfaces, control lines, and a control point. Further, the control surfaces, the control lines, and the control point are used to create constituent surfaces of a building.

Note that a building can also be configured by a figure having only constituent surfaces. However, in this case, it is difficult to create a simplified figure. Thus, it is better to create a 3D figure by using framework information on the control surfaces, the control lines, and the control point, and to display ground surfaces and structures configured with the framework information. When the control surfaces are simplified with the framework information, a simplified figure can be created.

FIG. 5 shows a specific method of creating a detailed figure and a simplified figure. A detailed 3D FIG. 504 is created by using control surfaces 501 and 502 and a control point 503. To create the detailed 3D FIG. 504, the control surfaces 501 and 502 are linked and the control surface 502 and the control point 503 are linked.

For a simplified figure, all the control surfaces are expressed by circumscribed rectangles. Through the transformation into the circumscribed rectangles, a control surface 505 is created by simplifying the control surface 501 and a control surface 506 is created by simplifying the control surface 502. The control point 503 is not changed.

The control surfaces 505 and 506 are linked and the control surface 506 and the control point 503 are linked, thereby creating a simplified 3D FIG. 508.

Hereinafter, the embodiment of the present invention will be described with reference to the drawings.

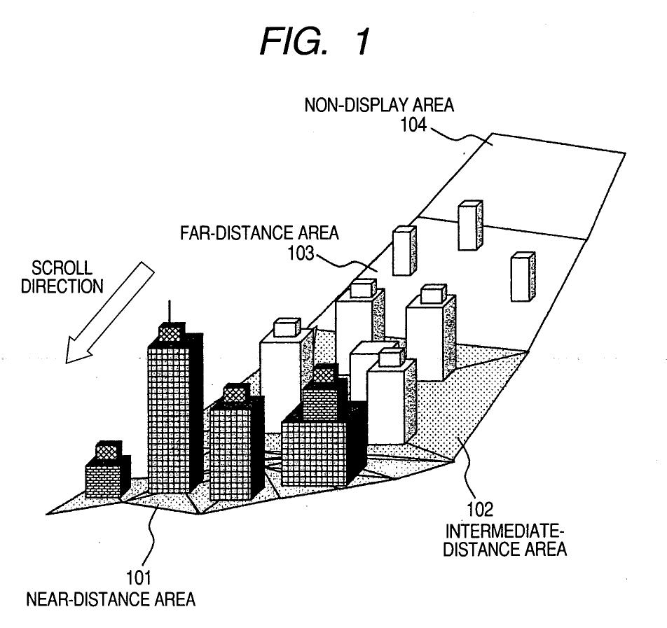

FIG. 1 shows a 3D map displayed according to the embodiment of the present invention.

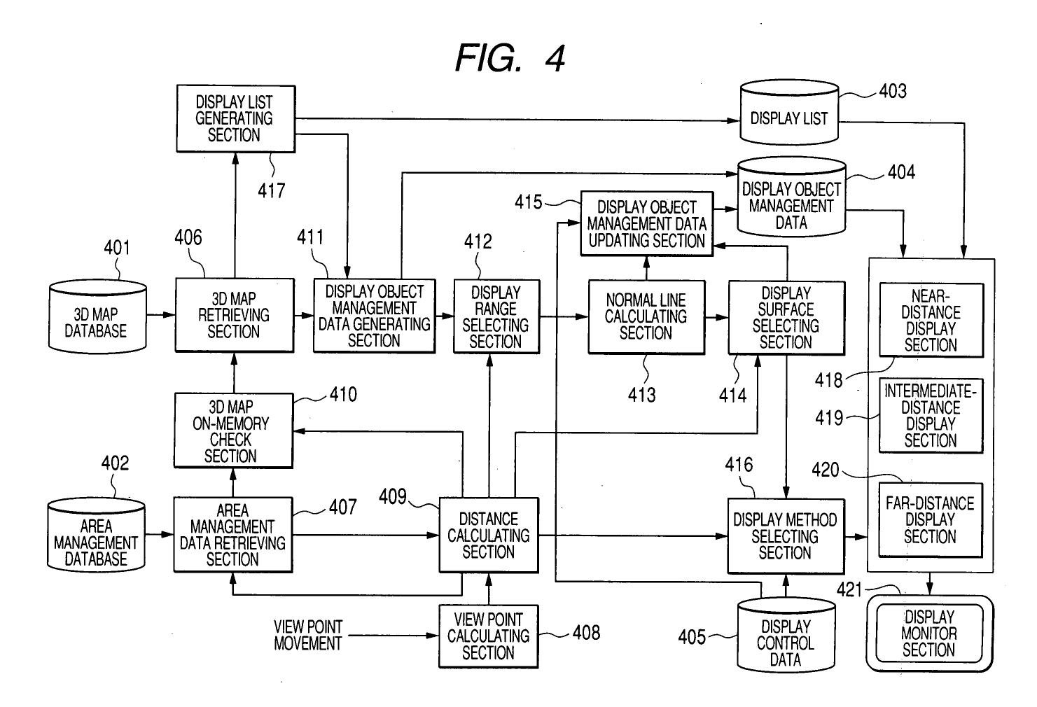

In this embodiment, ground surface data and structure data are displayed at four classified levels corresponding to areas obtained by partitioning the ground surface according to predetermined coordinates. To facilitate understanding of this embodiment, the areas corresponding to the four classified levels are called a near distance area, an intermediate distance area, a far distance area, and a no-display area. The number of classified levels is not limited to four. Since the number of classified levels is defined by display control data 405 (see FIG. 4), the number of display patterns can be increased by increasing the number of display-pattern definitions according to the number of classified levels. A change in the number of classified levels does not impair generality of the present invention. This embodiment shows an example display method at four levels.

(1) Near Distance Area 101

In a near distance area 101, a photograph is attached to the ground surface to display real landscape. In addition, buildings and structures are displayed in a detailed manner. Further, to surfaces constituting the buildings and structures, image data corresponding to real landscape photograph texture images is attached.

(2) Intermediate Distance Area 102

In an intermediate distance area 102, a graphically-filled ground surface is displayed. A shading effect or the like is applied to give an appearance of depth to 3D figures, as in a far distance area 103. Buildings and structures are graphically displayed similarly to the ground surface. The figures of the buildings and structures are not simplified.

(3) Far Distance Area 103

In the far distance area 103, a plane ground surface is displayed. A shading effect or the like is applied to give an appearance of depth to 3D figures. Only high buildings and structures are displayed and low buildings and structures are omitted (not displayed). A building constituted by multiple structures is displayed in a simplified manner after control surfaces (see FIG. 5) are transformed into circumscribed rectangles. As a result, the amount of display data can be reduced.

(4) No-display Area 104

In an area farther than the far distance area 103 and an area that does not face the view line direction, neither ground surfaces nor buildings are displayed.

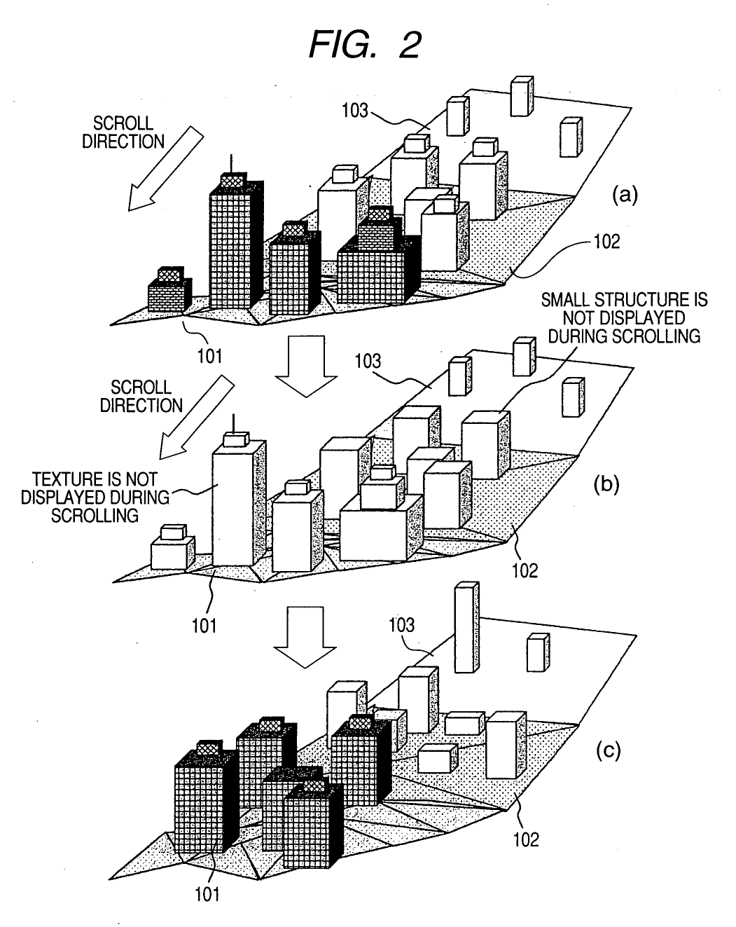

When a 3D map is scrolled, the display states of ground surfaces and structures are continuously changed in the respective areas. FIGS. 2A, 2B, and 2C show changes in display caused by a scrolling action. FIG. 2A shows the state of display before the scrolling action is started, and shows the 3D map in the same state as in FIG. 1.

Next, as shown in FIG. 2B, when the view point is changed, the 3D map is scrolled. Note that this scrolling action is performed also when the view line direction is changed, as in the case where the view point is changed. FIG. 2B shows the state of display during the scrolling action. During the scrolling action, in order to increase the display speed as described above, all pieces of real landscape photograph data temporarily disappear and the 3D map is just graphically displayed.

When the 3D map is scrolled in the direction indicated by an arrow shown in FIG. 2B, structures located in a remote area become closer. Accordingly, the area that was a no-display area becomes a far distance area. Thus, among buildings, only buildings that have height higher than a predetermined threshold are displayed. Further, the area that was a far distance area becomes an intermediate distance area. Thus, the buildings that were displayed in the simplified manner are displayed with detailed figures. The ground surface and structures are graphically displayed.

Further, the area that was an intermediate distance area becomes a near distance area. Thus, the buildings that were graphically displayed are displayed with real landscape photograph texture images being attached thereto when their real landscape photograph texture images exist. The area that was a near distance area passes through the view point to disappear from the view and becomes a rear area, which is not displayed.

FIG. 2C shows the state of display obtained when the scrolling action is stopped. When the scrolling action is stopped, structures and the ground surface included in the near distance area are displayed again with photographs being attached thereto.

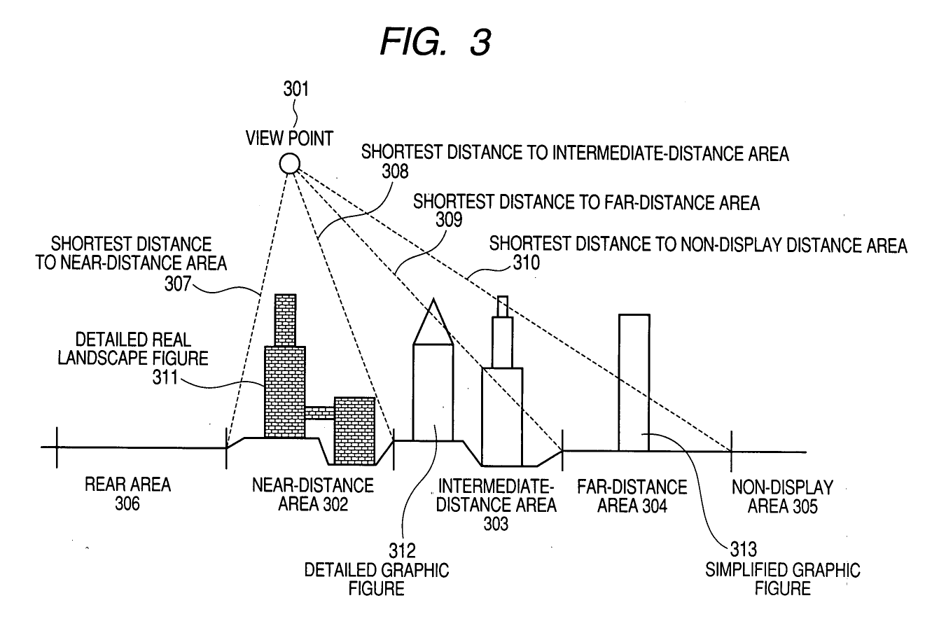

FIG. 3 shows a cross section viewed from the direction perpendicular to the view line direction.

The displayed map is partitioned into areas having dimensions determined in advance. The areas are classified into a near distance area, an intermediate distance area, a far distance, and a no-display area, depending on a distance from a view point 301.

Specifically, an area 302 is the near distance area because a shortest distance 307 from the view point 301 is equal to or less than a predetermined threshold (Lₙₑₐᵣ). In the near distance area 302, a detailed real landscape FIG. 311 to which a real landscape photograph texture image is attached and the ground surface to which a real landscape photograph texture image is attached are displayed. An area 303 is the intermediate distance area because a shortest distance 308 from the view point 301 is larger than the predetermined threshold (Lₙₑₐᵣ) and is equal to or less than a predetermined threshold (L_{middle}). In the intermediate distance area 303, a detailed graphic FIG. 312 and the graphic ground surface are displayed.

An area 304 is the far distance area because a shortest distance 309 from the view point 301 is larger than the predetermined threshold (L_{middle}) and is equal to or less than a predetermined threshold (L_{far}). In the far distance area 304, a structure that is higher than the predetermined threshold is displayed with in a simplified manner as a simplified graphic FIG. 313.

An area 305 is the no-display area because a shortest distance 310 from the view point 301 is larger than the predetermined threshold (L_{far}). In the no-display area 305, neither the ground surface nor structures are displayed.

Further, an area 306 located behind the view point 301 is a rear area when each angle formed by the view line vector and each of the four corners of the area 306 is 90 degrees or more, even if the shortest distance from the view point 301 is equal to or less than the threshold Lₙₑₐᵣ. In the rear area 306, neither structures nor the ground surface are displayed. In other words, detailed 3D figures as displayed in the near distance area 302 and the intermediate distance area 303, and simplified 3D figures as displayed in the far distance area 304 are not displayed in the rear area 306.

As described above, the content of display is changed according to the attribute of each of the areas, so that higher-speed display and scroll processing can be performed.

FIG. 4 shows an example of the configuration of the 3D map display system, which performs the higher-speed display and scroll processing.

The 3D map display system of this embodiment can be realized by software. Specifically, the 3D map display system is realized when a processor provided in a computer executes a predetermined program. Hereinafter, a description is given of function blocks of processing performed by the program.

A 3D map database 401 stores 3D map data. An area management database 402 stores data (area management data) used to manage area information.

A display list 403 is a structure member which describes display processing and parameters (for example, display data itself) for the display processing, and is preferably implemented by special hardware. Display object management data 404 specifies the graphic display method and the real landscape photograph texture display method, for the surfaces on structures and the ground surfaces. Display control data 405 specifies display settings for the near distance area, the intermediate distance area, and the far distance.

A 3D map retrieving section 406 retrieves a 3D map from the 3D map database 401 based on area information stored in the area management database 402, creates constituent surfaces from control surfaces, control lines, and a control point, creates a 3D figure surrounded by the constituent surfaces, and stores the 3D figure in a memory. Further, the 3D map retrieving section 406 simplifies the 3D figure by changing the control surfaces and control lines. An area management data retrieving section 407 retrieves area management data from the area management database 402.

A view point calculating section 408 calculates the coordinates of the view point, and a view line vector (a combination of the coordinates of the view point and the coordinates of any point in the view line direction), from information obtained through an operation with a device such as a keyboard and a mouse. A distance calculating section 409 calculates the distance from the view point to a selected area.

A 3D map on-memory check section 410 checks whether data to be displayed has been read onto the memory.

A display object management data generating section 411 generates on the memory, as a part of the display object management data 404, a basic configuration to specify whether each constituent surface in 3D figure data which has been read onto the memory is to be displayed or not. A display range selecting section 412 determines, based on the distance from the view point to a selected area, a display method for the area (the near distance area, the intermediate distance area, or the far distance area).

A normal line calculating section 413 calculates a normal line vector of each constituent surface of a 3D figure and stores it in the display object management data 404. A display surface selecting section 414 selects a display surface based on the result obtained by calculating the inner product of the normal line vector and the view line vector. A display object management data updating section 415 stores, when the view line vector is changed, display/non-display information of a new display surface selected by the display surface selecting section 414, in the display object management data 404.

A display method selecting section 416 selects, for each area, an appropriate one of display functions (418 to 420) corresponding to near-distance display, intermediate-distance display, and far-distance display, based on the distance from the view point to the area, calculated by the distance calculating section 409. A display list generating section 417 generates the display list 403 based on the 3D figure created by the 3D map retrieving section 406, and stores the generated display list 403 in the memory.

A near-distance display section 418 displays a near distance area whose distance from the view point is defined as a near distance. An intermediate-distance display section 419 displays an intermediate distance area whose distance from the view point is defined as an intermediate distance. A far-distance display section 420 displays a far distance area whose distance from the view point is defined as a far distance.

A display monitor section 421 is a display device which displays a 3D map.

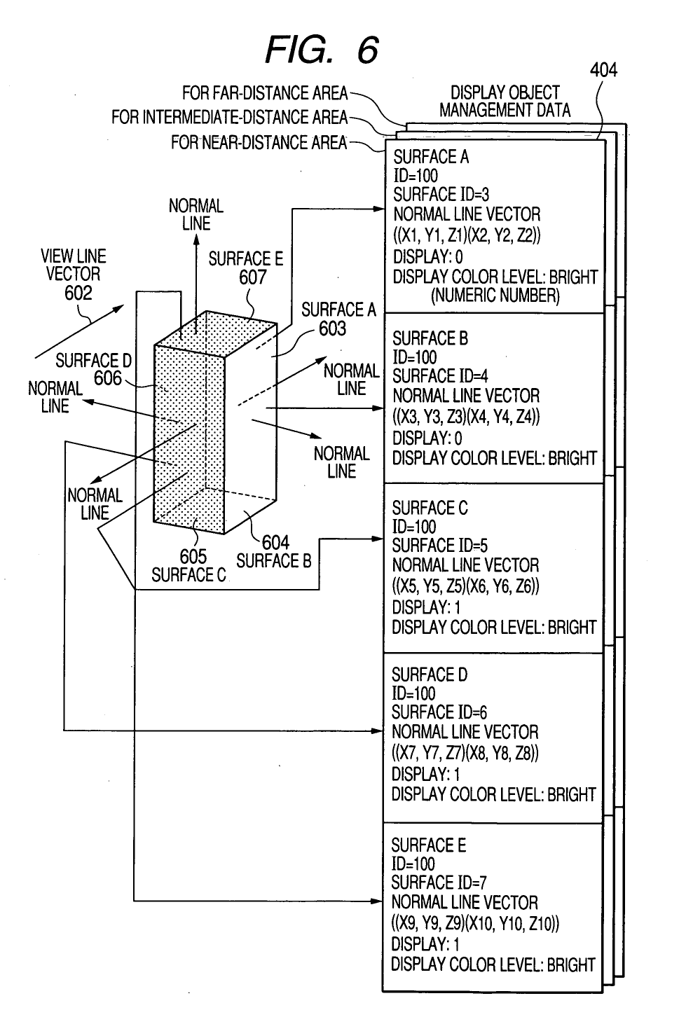

FIG. 6 shows the structure of the display object management data 404. The display object management data 404 of each constituent surface is generated for the near distance area, the intermediate distance area, and the far distance area. The display object management data 404 includes a figure ID, a surface ID, a normal line vector, display information, and a display color level.

The figure ID is the number unique to a figure on the ground surface, and is specified for each constituent surface. Each of control surfaces, control lines, and a control point has a unique number for classification. As the figure ID, the number of a control surface closer to the ground surface among the control surfaces is preferably selected. Specifically, in a 3D figure shown in FIG. 5, the number of a control surface 501 (in the far distance area, a control surface 505) is selected.

The surface ID is an identifier unique to a surface. The surface ID is also used as a display list number.

The normal line vector “NOR” is expressed by the coordinates of the start point and the end point of the vector, and can be obtained by the sum of the outer products of adjacent line segments, as shown in Expression (1). Note that the direction of a normal line vector is defined as the clockwise direction of each surface.

NOR=ΣPᵢ₊₁×Pᵢ Expression (1)

Note that Pᵢ₊₁ and Pᵢ are line segments between adjacent constituent surfaces.

As the display information, “1” (ON) is set when the corresponding surface is displayed, and “0” (OFF) is set when the corresponding surface is not displayed. For example, since rear surfaces that cannot be viewed from the view point are not displayed, the display states thereof are set to “0” (OFF). The display states of surfaces that can be viewed from the view point are set to “1” (ON).

For the display color level, a display color and the brightness of display are indicated by a value (brightness value). The display color is dark in the far distance area and bright in the intermediate distance area. The brightness value is set in the display control data 405.

The normal line vector is determined for all of ground surfaces and constituent surfaces of structures.

Next, the generation and use of the display object management data 404 will be described.

The display object management data 404 is generated for each area. The display object management data itself is determined for each ground surface and each constituent surface of a structure. Data on a constituent surface is developed on the memory by the 3D map retrieving section 406 and the display object management data 404 is generated. The display information in the display object management data 404 is generated and updated by the following method.

First, the inner product “INN” of the normal line vector of a constituent surface and the view line vector is calculated using Expression (2).

INN=|N∥V|cos α Expression (2)

In Expression (2), |N| is a positive value which indicates the length of the normal line vector, |V| is a positive value which indicates the length of the view line vector, “cos” is a cosine function, and a is an angle formed by the vector N and the vector V.

When the angle α is 90 degrees or less, “INN” is zero or a positive value. In this case, since the view line vector and the normal line vector are directed toward the same direction, the corresponding constituent surface is a rear surface. Accordingly, this surface is not displayed and the display information thereof is set to “0” (OFF). When the angle α exceeds 90 degrees, “INN” is a negative value. In this case, since the view line vector and the normal line vector are directed toward the opposite directions, the corresponding constituent surface can be viewed from the view point. Accordingly, this surface is displayed and the display information thereof is set to “1” (ON).

When the 3D map is scrolled, the normal line vector is not changed but the view line vector (the view point and the view line direction) is changed. Therefore, after the normal line vector is calculated once and registered in the display object management data 404, it is unnecessary to calculate the normal line vector again.

For example, as shown in FIG. 6, an angle α formed by the view line vector 602 and each of a surface A 603 and a surface B 604 is 90 degrees or less, so that the surface A 603 and the surface B 604 are rear surfaces and are not displayed (display information=“0” (OFF)). Further, an angle α formed by the view line vector 602 and each of a surface C 605, a surface D 606, and a surface E 607 exceeds 90 degrees, so that the surface C 605, the surface D 606, and the surface E 607 are displayed (display information=“1” (ON)).

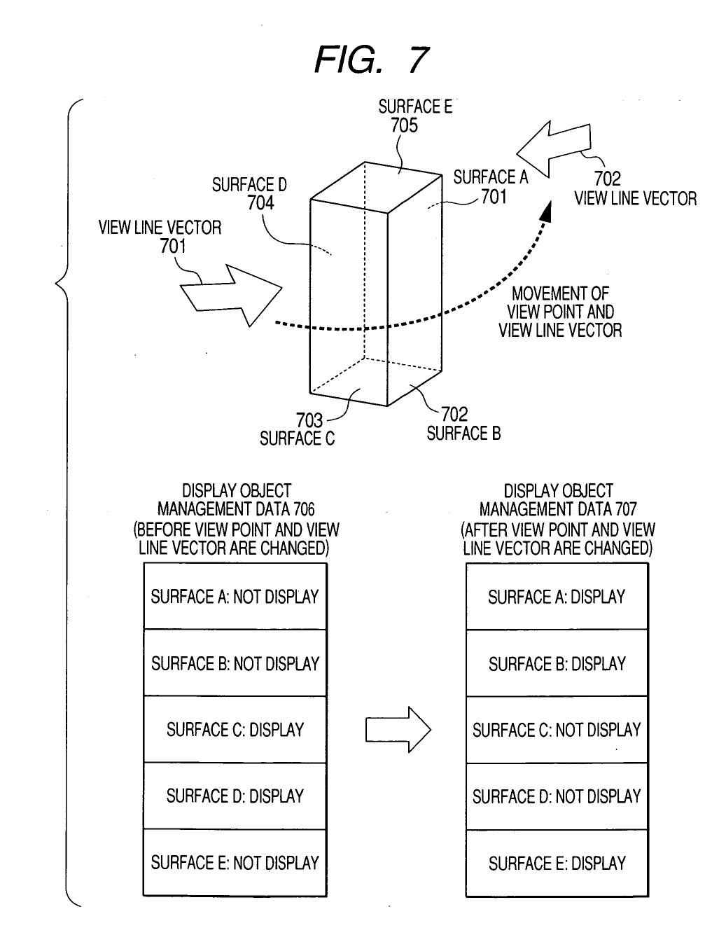

FIG. 7 shows changes in the display information when the view line vector is changed.

In display object management data 706 corresponding to a view line vector 701 before the change, a surface A 701, a surface B 702, and a surface E 705 are rear surfaces and are not displayed, and a surface C 703 and a surface D 704 are displayed because they face the view point. I contrast, when the view line vector is moved to the position of a view line vector 702, however, the surface A 701, the surface B 702, and the surface E 705 are displayed, but the surface C 703 and the surface D 704 are not displayed.

As described above, the display information is calculated every time the view line vector is changed. However, when the view line vector is shifted along its direction, the display information does not need to be calculated again. When the direction of the view line vector is changed by a rotation or the like, the display information needs to be calculated.

Next, the structure of the display control data 405 will be described. The display control data 405 specifies display methods and display parameters for the near distance area, the intermediate distance area, and the far distance area. Note that, as described above, the number of classified levels for display is not limited to three. The display types may be further classified by changing the parameters in the display control data 405. The display control data 405 includes parameters for distance, display methods, display colors, and height.

(1) Distance

The distance parameters included in the display control data 405 specifies two thresholds (Lₛ, Lₑ) for the shortest distance Lₘᵢₙ among the distances from the view point to the four corners of an area. When the shortest distance Lₘᵢₙ satisfies Expression (3), a display method corresponding to this distance is selected.

Lₛ<Lₘᵢₙ≦Lₑ Expression (3)

Note that, when an area does not face the view line direction, the area does not appear in the screen even when the area is determined to be displayed, based on the distance. Therefore, when angles formed by a plumb line vector from the view point and four vectors from the view point to the corners of the area exceeds 90 degrees, the area is determined to be located outside the view and is not displayed.

(2) Display Method

The display method parameters included in the display control data 405 specify real landscape photograph texture display, graphic texture display, and graphically filling display. In this embodiment, the real landscape photograph texture display is used in the near distance area, and the graphically filling display is used in the intermediate distance area. Note that, although an example using the graphic texture display, in which a graphically created texture is attached for display, is omitted in this embodiment, generality of the present invention is not impaired.

(3) Display Color Parameter

The display color parameters included in the display control data 405 specify a display color and the brightness for the graphically filling display.

(4) Height

The height parameter included in the display control data 405 specifies a threshold for height of a 3D figure to be displayed in the far distance area. In other words, 3D figures that have height equal to or less than the height parameter are not displayed in the far distance area.

The above-described items are specified for buildings and ground surfaces.

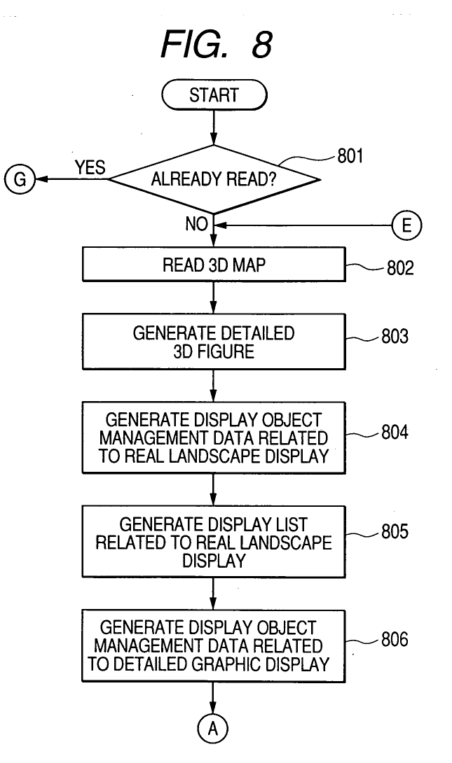

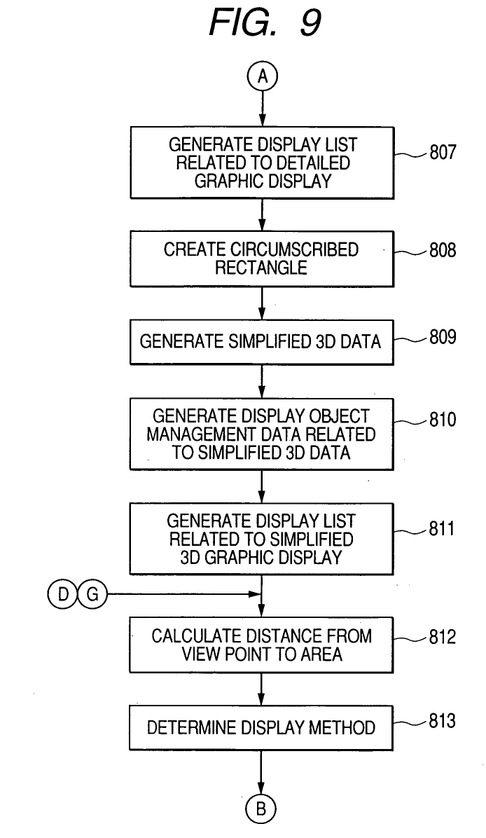

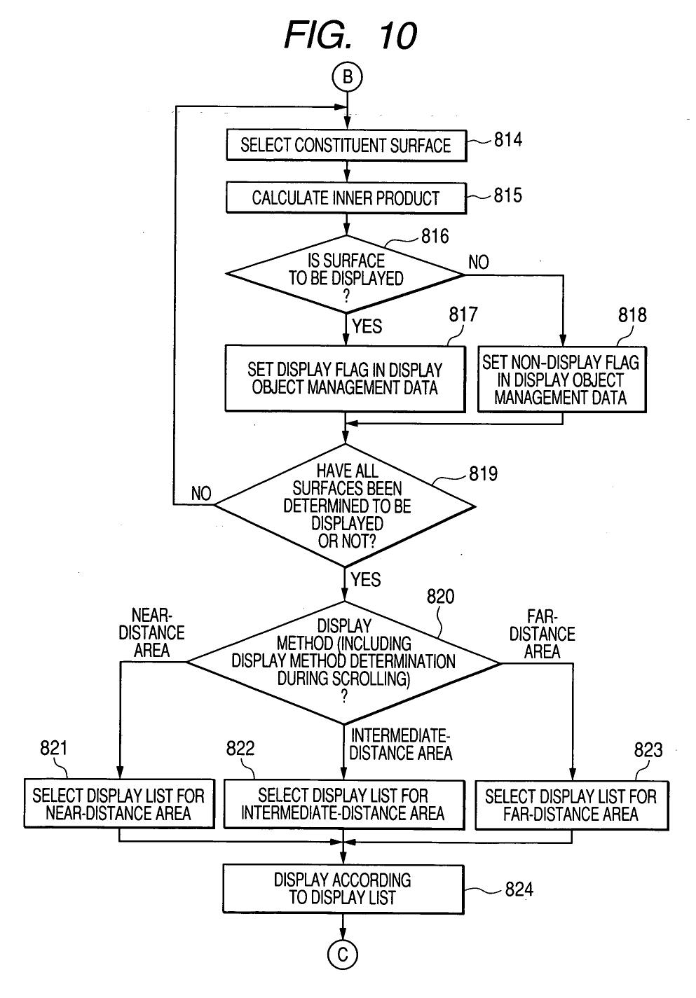

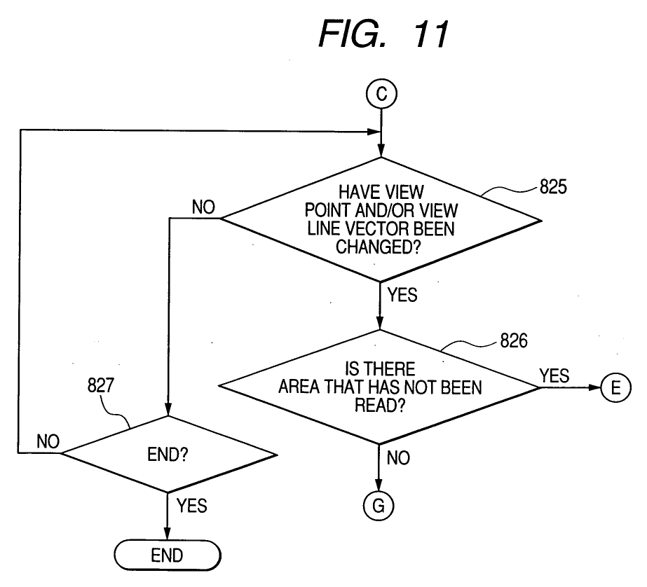

Next, a scroll processing procedure, including a reading process of 3D map data, will be described with reference to FIGS. 8 to 11.

It is assumed that view point coordinates and a view line vector are prepared in advance. The view point is indicated by 3D coordinates (X, Y, Z), and the view line vector is indicated by a combination of those view point coordinates and the 3D coordinates of a certain point in the view line direction.

Building data and ground surface data are managed in each of partitioned areas. The areas are managed by the area management database 402.

The area management database 402 includes (1) the coordinates of each of the four corners of an area (the coordinates according to the latitude and longitude or according to a predetermined coordinate system) and (2) the name and location of data where a 3D map and photograph texture information included in each area are stored. Note that, in the area management database 402, the 3D map may be managed for ground surfaces and buildings separately.

First, the area management data retrieving section 407 retrieves area management data stored in the area management database 402, and selects areas located in the view line direction starting from the view point, as areas located in a display range. In other words, an area group containing the field of view exactly is selected.

From the retrieved area management data, the names of files of 3D map data, containing the selected areas are retrieved. Those retrieved file names are sent to the 3D map on-memory check section 410.

Upon reception of the retrieved file names, the 3D map on-memory check section 410 determines whether the 3D map data has already been read onto the memory (Step 801). For example, 3D map data of an area which is being displayed has already been read onto the memory. In this case, processes of Step 812 and the subsequent steps are performed. On the other hand, when it is necessary to read 3D map data for initial display, or when it is necessary to read 3D map data of an area to be newly displayed during a scrolling action, processes of Steps 802 to 811 are first performed.

In Step 802, the 3D map retrieving section 406 reads 3D map data from the 3D map database 401 and develops the 3D map data on the memory of the computer.

The area management data stored in the area management database 402 includes a flag indicating whether 3D map data has been read from the 3D map database 401. The flag, related to 3D map data read onto the memory from the 3D map database 401, is set to “already read”. When 3D map data is deleted from the memory, the flag is set to “already deleted”.

Thereafter, the 3D map retrieving section 406, the display object management data generating section 411, and the display list generating section 417 generate display data for displaying the near distance area (Steps 803 to 805), generate display data for displaying the intermediate distance area (Steps 806 to 807), and generate display data for displaying the far distance area (Steps 808 to 811).

First, the 3D map retrieving section 406 connects control surfaces, control lines, and a control point of a 3D figure included in the 3D map data read onto the memory, generates data on constituent surfaces of a detailed 3D figure, and develops the generated 3D figure data on the memory (Step 803).

The display object management data generating section 411 generates the display object management data 404 for displaying the detailed 3D figure by using a real landscape in the near distance area (Step 804). The display object management data 404 for the near distance area includes the following information.
Figure ID: Unique number of a base control surface
Surface ID: Unique identifier of a surface, determined in Step 805
Normal line vector: Calculated by the normal line calculating section 413 using Expression (1)
Display information: Determined in Steps 817 and 818
Display color level: None (since the real landscape photograph texture display is used in the near distance area, a display color level is not specified)

Next, the display list 403 for displaying the detailed 3D figure by using a real landscape in the near distance area is generated (Step 805).

Specifically, in order to display data of the display range at higher speed, the display list generating section 417 generates the display list 403 for displaying the near distance area. The display list 403 is generated by a known algorithm. In this embodiment, the display list 403 is generated for detailed 3D figures which are obtained by mapping real landscape photograph texture images to figures of ground surfaces and structures, each of which is constituted by a control point, control lines, and control surfaces. A display list number is assigned to the generated display list 403. With this display list number being used as a surface ID, the generated display list 403 is included in the display object management data 404 generated in Step 804, by the display object management data generating section 411.

Next, to display the intermediate distance area, the 3D map retrieving section 406 connects control surfaces, control lines, and a control point of a 3D figure included in the 3D map data read onto the memory, generates data on constituent surfaces of a detailed 3D figure, and develops the generated 3D figure data on the memory. Note that the 3D figure data for displaying the near distance area, which has been generated in Step 803, may be used as the 3D figure data for displaying the intermediate distance area.

The display object management data generating section 411 generates the display object management data 404 for displaying the detailed 3D figure in the intermediate distance area (Step 806). The display object management data 404 for the intermediate distance area includes the following information.
Figure ID: Unique number of a base control surface
Surface ID: Unique identifier of a surface, determined in Step 807
Normal line vector: Calculated by the normal line calculating section 413 using Expression (1)
Display information: Determined in Steps 817 and 818
Display color level: Bright (indicated by a numeric value)

Next, the display list 403 for displaying the detailed 3D figure by using detailed graphic data in the intermediate distance area is generated.

Specifically, in order to display data of the display range at higher speed, the display list generating section 417 generates the display list 403 for displaying the intermediate distance area (Step 807). A display list number is assigned to the generated display list 403. With this display list number being used as a surface ID, the generated display list 403 is included in the display object management data 404 generated in Step 806, by the display object management data generating section 411.

Next, the 3D map retrieving section 406 creates rectangles that circumscribe the control surfaces (Step 808). As a method of creating a circumscribed rectangle, a known method which uses a primary moment axis can be used. Specifically, a moment axis of a surface is obtained by using a known algorithm, and the figure is rotated such that the direction of the moment axis becomes horizontal. Then, the maximum value and the minimum value of the coordinates are used to create a circumscribed rectangle. Thereafter, the figure is rotated in the direction of the original axis.

Further, the 3D map retrieving section 406 creates constituent surfaces by connecting a control point, control lines, and the control surfaces transformed into the circumscribed rectangles in Step 808, and generates simplified 3D figure data (Step 809).

Next, the display object management data generating section 411 generates the display object management data 404 for displaying the simplified 3D figure in the far distance area (Step 810). The display object management data 404 for the far distance area includes the following information.
Figure ID: Unique number of a base control surface
Surface ID: Unique identifier of a surface, determined in Step 811
Normal line vector: Calculated by the normal line calculating section 413 using Expression (1)
Display information: Determined in Steps 817 and 818
Display color level: Dark (indicated by a numeric value)

Next, the display list 403 for displaying the simplified 3D figure in the far distance area is generated.

Specifically, in order to display data of the display range at higher speed, the display list generating section 417 generates the display list 403 for the far distance area (Step 811). A display list number is assigned to the generated display list 403. With this display list number being used as a surface ID, the generated display list 403 is included in the display object management data 404 generated in Step 810, by the display object management data generating section 411.

When the view point and/or the view line direction is changed through a key operation or a mouse operation, the view point calculating section 408 calculates a view line vector by calculating the amount of coordinate change from a signal corresponding to the key operation or the mouse operation, and changes the coordinates indicating the view line vector as follows.

(X1, Y1, Z1)→(X3, Y3, Z3)

(X2, Y2, Z2)→(X4, Y4, Z4)

In this notation, (X1, Y1, Z1) indicates the coordinates of the previous view point, and (X3, Y3, Z3) indicates the coordinates of the current view point. Further, (X2, Y2, Z2) indicates the coordinates of any point on the previous view line direction, and (X4, Y4, Z4) indicates the coordinates of any point on the current view line direction.

A key operation for changing the view line direction is defined by each system. For example, the view line direction may be changed by operating a particular key on the keyboard. Alternatively, the view line direction may be changed by operating a mouse.

The distance calculating section 409 calculates the distances from the view point to the four corners of each area included in the data developed on the memory of the computer in Step 803 (Step 812). It is assumed that the distances from the view point to the four corners are L1, L2, L3, and L4. The minimum distance is selected among those distances, and the minimum distance (Lₘᵢₙ) is compared with the predetermined thresholds (Lₛ, Lₑ) included in the display control data 405.

Next, the display range selecting section 412 determines the attribute of each area among the near distance area, the intermediate distance area, and the far distance area to determine the display method for the area (Step 813). The above-mentioned thresholds Lₙₑₐᵣ, L_{middle}, and L_{far} are used, which are included in the display control data 405. When the minimum distance (Lₘᵢₙ) of an area satisfies Expression (4), the area is determined to be the near distance area.

Lₘᵢₙ≦Lₙₑₐᵣ Expression (4)

Further, when the minimum distance (Lₘᵢₙ) of an area satisfies Expression (5), the area is determined to be the intermediate distance area.

Lₙₑₐᵣ<Lₘᵢₙ≦L_{middle} Expression (5)

Further, when the minimum distance (Lₘᵢₙ) of an area satisfies Expression (6), the area is determined to be the far distance area.

L_{middle}<Lₘᵢₙ≦L_{far} Expression (6)

Further, when the minimum distance (Lₘᵢₙ) of an area satisfies Expression (7) or when an area is determined to be a rear area by the above-mentioned method, the area is determined to be a no-display area.

L_{far}<Lₘᵢₙ Expression (7)

Next, the display surface selecting section 414 selects ground surfaces and constituent surfaces of structures, which constitute the 3D map (Step 814). Processes of Step 814 and the subsequent steps correspond to an algorithm for determining whether each of the constituent surfaces is to be displayed or not.

The display surface selecting section 414 calculates an inner product of the view line vector and the normal line vector of a constituent surface, and determines whether the value of “cos α” shown in Expression (2) is a positive value or a negative value (Step 815). When the value of “cos α” is a positive value, “INN” is a positive value. When the value of “cos α” is a negative value, “INN” is a negative value. When “INN” is a positive value, the surface is determined to be a no-display surface. When “INN” is a negative value, the surface is determined to be a display surface.

Next, the display surface selecting section 414 determines whether each constituent surface is a display surface or a no-display surface (Step 816). When the constituent surface is a display surface, a process of Step 817 is performed. When the constituent surface is a no-display surface, a process of Step 818 is performed.

In Step 817, the display object management data updating section 415 stores “1” (ON), indicating display, as the display information, in the display object management data 404. The flow advances to Step 819.

On the other hand, in Step 818, the display object management data updating section 415 stores “0” (OFF), indicating no-display, as the display information, in the display object management data 404. The flow advances to Step 819.

It is determined whether all constituent surfaces have been determined to be displayed or not (Step 819). When all constituent surfaces have been determined to be displayed or not, the flow advances to Step 820. When a part of constituent surfaces has not been determined to be displayed or not, the flow returns to Step 814 to select a next constituent surface.

When all constituent surfaces have been determined to be displayed or not, the display method selecting section 416 selects the display list 403 to be used for display processing based on the display method determined in Step 813. Specifically, the display method selecting section 416 performs a process of Step 821 when a constituent surface is included in the near distance area and is to be displayed, performs a process of Step 822 when a constituent surface is included in the intermediate distance area and is to be displayed, and performs a process of Step 823 when a constituent surface is included in the far distance area and is to be displayed. While a scrolling action is being performed, the near distance area is displayed (specifically, graphically displayed) at the same time as the intermediate distance area. When a scrolling action is not performed, the near distance area is displayed using a real landscape photograph texture. During a scrolling action, a real landscape photograph texture is not displayed even for the near distance area, so that the display speed can be increased.

In Step 821, the near-distance display section 418 selects the display list number (surface ID) from the display list 403 for the near distance area, and the flow advances to Step 824. In Step 822, the intermediate-distance display section 419 selects the display list number (surface ID) from the display list 403 for the intermediate distance area, and the flow advances to Step 824. In Step 823, the far-distance display section 420 selects the display list number (surface ID) from the display list 403 for the far distance area, and the flow advances to Step 824.

Each of the near-distance display section 418, the intermediate-distance display section 419, and the far-distance display section 420 reads the display object management data 404 by using the corresponding display list number, and displays the 3D map on the display monitor section 421. At that time, only display-target surfaces which have been determined to be display surfaces in Step 816 are displayed, and surfaces which have been determined to be no-display surfaces in Step 816 are not displayed.

After the 3D map is displayed, it is determined whether a further scrolling action has been performed, by monitoring a signal generated through a key operation or a mouse operation (Step 825). When the view line vector (the view point and the view line direction) is changed, the flow advances to Step 826. When the view line vector is not changed, the flow advances to Step 827.

In Step 826, when a 3D map displayed anew after the view line vector was changed includes a new display area, the flow returns to Step 802 and 3D map data of the new display area is read. On the other hand, when a new display area is not included, the flow returns to Step 812.

In Step 827, in order to continue the display, the flow returns to Step 825 and it is determined whether the view line vector has been changed.

The present invention relates to a geographic information system, and provides a method of displaying and scrolling, at higher speed, a 3D real landscape image in which a photograph image is attached to ground surfaces and wall surfaces and a top surface of a building. According to the present invention, ground surfaces and a rear surface of a structure which are not viewed are not displayed. Further, only an area near the view point is displayed in a realistic manner by attaching photographs thereto, and areas far from the view point are graphically displayed. Further, to move the view point, the 3-D map is scrolled with the photograph display being temporarily stopped. As a result, the load of hardware for display is reduced and display and scroll are performed at higher speed.

According to the present invention, in displaying a 3D map having detailed figures even for ground surfaces and structures with complicated figures, complicated 3D figures and their real landscape photograph texture images are displayed at higher speed. In particular, for an application to landscape estimation for which a detailed city figure is displayed, a scrolling action is absolutely necessary. In such a case, a 3D map is displayed at higher speed also during the scrolling action. Further, even for an application related to entertainment such as games, a higher-speed scrolling action can be realized for background data.

What is claimed is:

1. A three-dimensional map display system which outputs display information on a three-dimensional map, comprising:
a processor for performing arithmetic processing; and
a storage device connected to the processor, wherein:
the storage device stores three-dimensional map vector data for each of partitioned areas determined in advance according to coordinates and a real landscape photograph texture image to be attached to the three-dimensional map vector data;
the processor determines whether to display each surface constituting a three-dimensional figure included in the three-dimensional map vector data;
the processor stores display object management data which includes a result of the determination as to whether to display the surface, in the storage device; and
the processor refers to the display object management data stored in the storage device to determine that only a surface that faces a view line direction is to be displayed and that a surface that does not face the view line direction is not to be displayed, to reduce the amount of display data.

2. A three-dimensional map display system according to claim 1, wherein:
the processor calculates an inner product of a view line vector and a normal line vector of a display object surface stored in the display object management data;
the processor determines that the display object surface is not to be displayed when the calculated inner product is zero or a positive value, because the display object surface does not face the view line direction;
the processor determines that the display object surface is to be displayed when the calculated inner product is a negative value, because the display object surface faces the view line direction;
the processor updates the display object management data based on a result of the determination as to whether to display the display object surface; and
the processor refers to the display object management data to select a surface to be displayed.

3. A three-dimensional map display system according to claim 1, wherein:
multiple attributes are specified for each of the areas depending on the distance from a view point; and
the processor specifies the display object management data corresponding to the attributes of each of the areas.

4. A three-dimensional map display system according to claim 3, wherein:
the multiple attributes of each of the areas include a far distance;
the processor simplifies, when an area included in the three-dimensional map vector data has an attribute of the far distance, a figure of a structure included in the far distance area; and
the processor determines whether to display each surface constituting the simplified figure.

5. A three-dimensional map display system according to claim 1, wherein:
the processor attaches no real landscape photograph texture image to the surface of the three-dimensional figure while a scrolling action is being applied to the three-dimensional map; and
the processor attaches a real landscape photograph texture image to the surface of the three-dimensional figure when the scrolling action is stopped.

6. A three-dimensional map display system according to claim 1, wherein:
the processor determines that an area that does not exist in the view line direction viewed from a view point is a rear area; and
the processor determines that three-dimensional map vector data corresponding to the area determined to be a rear area is not displayed.

7. A three-dimensional map display system according to claim 1, wherein:
the storage device stores the display object management data which includes a result of the determination as to whether to display the surface and a display list which includes data on the three-dimensional figure; and
the display object management data further includes information on a display method for each display surface and a normal line of each display surface.

8. A three-dimensional map display method of displaying a three-dimensional map in a computer which comprises a processor for performing arithmetic processing and a storage device connected to the processor, the storage device storing three-dimensional map vector data for each of partitioned areas determined in advance according to coordinates and a real landscape photograph texture image to be attached to the three-dimensional map vector data, and the three-dimensional map display method comprising the steps of:
determining whether to display each surface constituting a three-dimensional figure included in the three-dimensional map vector data;
storing display object management data which includes a result of the determination as to whether to display the surface, in the storage device; and
referring to the display object management data stored in the storage device to determine that only a surface that faces a view line direction is to be displayed, and that a surface that does not face the view line direction is not to be displayed, to reduce the amount of display data.

9. A three-dimensional map display method according to claim 8, further comprising the steps of:
calculating an inner product of a view line vector and a normal line vector of a display object surface stored in the display object management data;
determining that, the display object surface is not to be displayed when the calculated inner product is zero or a positive value, because the display object surface does not face the view line direction;
determining that the display object surface is to be displayed when the calculated inner product is a negative value, because the display object surface faces the view line direction;
updating the display object management data based on a result of the determination as to whether to display the display object surface; and
referring to the display object management data to select a surface to be displayed.

10. A three-dimensional map display method according to claim 8, wherein:
multiple attributes are specified for each of the areas depending on the distance from a view point; and
the display object management data is specified corresponding to the attributes of each of the areas.

11. A three-dimensional map display method according to claim 10, wherein:
the multiple attributes of each of the areas include a far distance; and
the three-dimensional map display method further comprises the steps of:
simplifying, when an area included in the three-dimensional map vector data has an attribute of the far distance, a figure of a structure included in the far distance area; and
determining whether to display each surface constituting the simplified figure.

12. A three-dimensional map display method according to claim 8, further comprising the steps of:
attaching no real landscape photograph texture image to the surface of the three-dimensional figure while a scrolling action is being applied to the three-dimensional map; and
attaching a real landscape photograph texture image to the surface of the three-dimensional figure when the scrolling action is stopped.

13. A three-dimensional map display method according to claim 8, further comprising the steps of:
determining that an area that does not exist in the view line direction viewed from a view point is a rear area; and
determining that three-dimensional map vector data corresponding to the area determined to be a rear area is not displayed.

14. A three-dimensional map display method according to claim 8, further comprising the steps of:
storing the display object management data which includes a result of the determination as to whether to display the surface and a display list which includes data on a three-dimensional figure included in the three-dimensional map, in the storage device; and
incorporating information on a display method for each display surface and a normal line of each display surface, in the display object management data.

15. A program causing a computer to display a three-dimensional map, the computer comprising a processor for performing arithmetic processing and a storage device connected to the processor, the storage device storing three-dimensional map vector data for each of partitioned areas determined in advance according to coordinates and a real landscape photograph texture image to be attached to the three-dimensional map vector data, and the program causing the computer to execute the steps of:
determining whether to display each surface constituting a three-dimensional figure included in the three-dimensional map vector data;
storing display object management data which includes a result of the determination as to whether to display the surface, in the storage device; and
referring to the display object management data stored in the storage device to determine that only a surface that faces a view line direction is to be displayed, and that a surface that does not face the view line direction is not to be displayed, to reduce the amount of display data.

16. A program according to claim 15, further causing the computer to execute the steps of:
calculating an inner product of a view line vector and a normal line vector of a display object surface stored in the display object management data;
determining that the display object surface is not to be displayed when the calculated inner product is zero or a positive value, because the display object surface does not face the view line direction;
determining that the display object surface is to be displayed when the calculated inner product is a negative value, because the display object surface faces the view line direction;
updating the display object management data based on a result of the determination as to whether to display the display object surface; and
referring to the display object management data to select a surface to be displayed.

17. A program according to claim 15, further causing the computer to execute the steps of:
simplifying, when an area included in the three-dimensional map vector data is a far distance area, a figure of a structure included in the far distance area; and
determining whether to display each surface constituting the simplified figure.

18. A program according to claim 15, further causing the computer to execute the steps of:
attaching no real landscape photograph texture image to the surface of the three-dimensional figure while a scrolling action is being applied to the three-dimensional map; and
attaching a real landscape photograph texture image to the surface of the three-dimensional figure when the scrolling action is stopped.

19. A program according to claim 15, further causing the computer to execute the steps of:
determining that an area that does not exist in the view line direction viewed from a view point is a rear area; and
determining that three-dimensional map vector data corresponding to the area determined to be a rear area is not displayed.
